(19) United States
(12) Patent Application Publication
(10) Pub. No.: US 2022/0347800 A1
(43) Pub. Date: Nov. 3, 2022

(54) BRIDGE AND BODY EMBODIMENT FOR LASER CUTTING MACHINE

(71) Applicant: BAYKAL MAKINA SANAYI VE TICARET ANONIM SIRKETI, Bursa (TR)

(72) Inventors: Emre FIDAN, Bursa (TR); Ibrahim MANZAK, Bursa (TR); Tugba BILGIN, Bursa (TR)

(21) Appl. No.: 17/607,863

(22) PCT Filed: Oct. 27, 2020
(86) PCT No.: PCT/TR2020/050995

§ 371 Date: Oct. 29, 2021

(51) Int. Cl. B23K 37/02; B23K 26/38

(52) U.S. Cl. CPC B23K 37/0288; B23K 26/38

(57) ABSTRACT

Disclosed is a bridge and body embodiment used in laser cutting machines. The embodiment has two bodies located facing each other and extending along at least a first guide component on an inner surface longitudinally, a bridge moving back and forth on the first guide component by at least one second guide component connected in between the bodies in perpendicular form and connected onto both side surfaces, a first driving component located on both side surface of the bridge or the inner surface of the body providing moving of the bridge, and a second driving component located on the body inner surface and providing movement of the first driving component on the inner surface of the body.

### TECHNICAL FIELD

Invention relates to a bridge and body embodiment used in laser cutting machines.

Invention particularly relates to bridge and body embodiment providing performance of quality cutting at high accelerations by help of coincidence of driving point and weight axis by means of perpendicular connection of bridge where cutting head group move to body.

### STATE OF THE ART

Laser cutting machines are machines providing drilling, cutting and/or marking of 2-dimension sheet plates of various sizes and thicknesses according to processing pictures and programs. Said laser cutting machines basically, comprises laser integrated cutting head group connected to the bridge group moving back-forth by means of driving mechanism located on the body to perform operations applied onto sheet plate. This group can move horizontally, vertically and in combination thereof on bridge.

Two ends of the moving bridge group where cutting head group performing drilling, cutting and/or marking operations applied onto sheet plate in the related art are connected to the body in parallel way from upper part of body on the right and left sides of the body. Driving mechanism moving the bridge group on the body is connected to the body. For that reason, centre of gravity axis of the bridge is far from driving point. Accordingly, machine acceleration is limited by engines on driving mechanism and reaching high acceleration of bridge group is prevented. Enhancement of engines is required to increase acceleration of bridge group. However, such change causes increase in manufacturing cost, power consumption and bridge group weight. Increase in bridge group weight and acceleration simultaneously causes increase in total force (F=m.a) having influence on bridge group and therefore negative impacts on cutting quality during bridge group movement. Particularly cutting quality in small round parts occur because of any vibration and/or strain that might occur in bridge of laser cutting machines or machine. For that reason, it is necessary to have a correlation in between bridge centre of gravity axis and driving point in bridge group weight. However, in the related art this correlation gets lost upon increase in acceleration in laser cutting machines where bridge group is parallel connected to body from upper part of bridge group.

The document numbered TR2014/04881 can be shown as example for related art in the research conducted in the literature. Said document relates to top suspended laser cutting machine. Laser cutting machine of said invention comprises basically monoblock welded construction main body, movement mechanism that provides the movement of laser head on the workpiece, motion slides where movement mechanism moves on X and Y axis, movement mechanism slide and trolley providing connection of movement mechanism to motion slides and providing moving thereof. X axis moving slide top suspended is located on main body top panel in parallel to main body length and X axis horizontal moving engine-reducer is located on central point of X axis moving slide. Thus, invention provides to have main body allowing to be placed into standard hard-top container together with all moving equipment of main body and accordingly saving in transport costs and space of use. However, said laser cutting machine shows that top part of body of bridge group has a structure connected to body from top part parallel to body. This causes cutting quality problems.

The document numbered TR2016/19969 can be shown as another example for related art. Said document relates to laser cutting machine body embodiment. Said invention comprises two carrying bodies located facing each and equipped with a rear body, a bridge moving back-forth on the carrying bodies, trolley moving on the bridge, cutting head connected onto trolley and a suction system associated with carrying bodies. Bridge carrying cutting head is connected to in parallel to body from top part of the body. Therefore, in the bridge group weight a correlation in between bridge centre of gravity axis and driving point cannot be provided and quality of cutting problems are possible to occur.

As a result, the because of existence the said problems mentioned above and inadequacy of solutions, it has been necessary to make a development in the related art.

### PURPOSE OF THE INVENTION

This present invention relates to a bridge and body embodiment for laser cutting machine eliminating above mentioned disadvantages and providing new advantages in the related art.

Primary purpose of the invention is to achieve the bridge group embodiment, providing performance of quality cutting at high accelerations by help of coincidence of driving point and weight axis by means of perpendicular connection of the bridge where cutting head group move to the body.

Purpose of the invention is to provide shorten length by means of connection of bridge perpendicular to body and accordingly achieve a more rigid structure and thus increase strength.

A further purpose of the invention is to enhance cutting quality as a result of increase in inertia momentum of bridge thanks to coincidence of driving point and weight axis by connection of bridge to body perpendicularly and decrease in displacement that might occur on the bridge.

Another purpose of the invention is to provide obtaining higher accelerations without having any cutting quality problem by use of the same engine in the laser cutting machine thanks to coincidence of driving point and weight axis by connection of bridge to body perpendicularly.

In order to achieve all purposes described above and elicited from detailed description, the invention is a bridge and body embodiment used in laser cutting machines and comprises
two bodies located facing each other and extending at least a guide component-1 along length on inner surface,
bridge moving back and forth on guide component-1 by means of at least one guide component-2 connected between bodies in perpendicular way and connected to both side surfaces,
driving component-1 located on both side surfaces of bridge or on inner surface of body and providing movement of the bridge,
a driving component-2 located on inner surface of body and providing movement of driving component-1.

The structural and characteristic features and all advantages of the invention will be understood more clearly with the figures given below and the detailed description by reference to the figures. Therefore, the assessment should be made based on the figures and taking into account the detailed descriptions.

### BRIEF DESCRIPTION OF THE DRAWINGS

FIG. 1 is perspective view of bridge and body embodiment of the invention.

FIG. 2 is front view of bridge and body embodiment of the invention.

FIG. 3 is an illustrative view of bridge weight axis and bridge driving point of bridge and body embodiment of the invention.

### DESCRIPTION OF PART REFERENCES

10. Body

11. Guide component-1

20. Bridge

21. Guide component-2

30. Driving component-1

40. Driving component-2

a. Bridge weight axis

b. Bridge driving point

### DETAILED DESCRIPTION OF THE INVENTION

In this detailed description, the preferred alternatives of the bridge (20) and body (10) embodiment being subject of the invention have been described in a manner not forming any restrictive effect and only for purpose of better understanding of the matter.

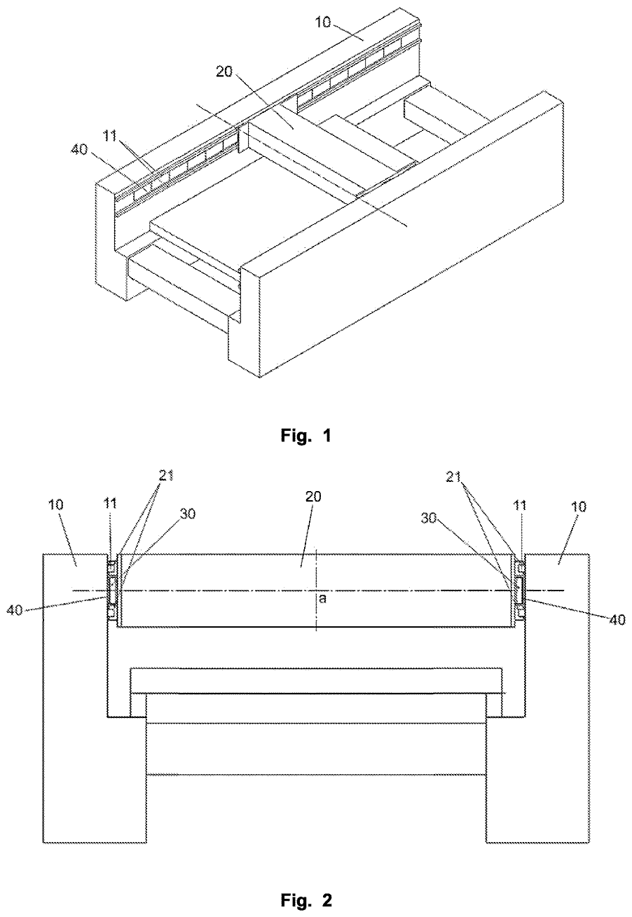

FIG. 1 shows perspective view of the bridge (20) and the body (10) embodiment of the invention. Accordingly, in most basic form, the bridge (20) and the body (10) embodiment comprises two bodies (10) located facing each other and extending along at least a guide component-1 (11) on inner surface longitudinally, a bridge (20) moving back and forth on guide component-1 (11) by means of guide component-2 (21) connected between bodies (10) in perpendicular form and connected onto both side surfaces, driving component-1 (30) providing moving of the bridge (20) on both side surface of the bridge (20), driving component-2(40) providing movement of driving component-1 (30) on inner surface of the body (10).

The bodies (10) carrying the bridge (20) where cutting head group (not shown in picture) realizing drilling, cutting and/or marking operations on sheet plate in laser cutting machine is connected are located facing each other and at least one guide component-1(11) extends along length on inner surface.

The bridge (20) is connected between the bodies (10) in perpendicular form and as shown in FIG. 2, at least one guide component-2 (21) is located on both side surfaces.

The bridge (20) moves back and forth on guide component-1 (11) on inner surface of body (10) by means of said guide component-2 (21). Driving component-1 (30) is connected onto both side surfaces of bridge (20) in order to enable movement of the bridge (20) on the guide component-1 (11). The said driving component-1 (30) can also be connected to body (10) inner surface. Movement of the driving component-1 (30) is provided by means of a driving component-2 (40) located on inner surface of the body (10) and between guide component-1 (11).

Working principle of bridge (20) and body (10) embodiment of the invention is as follows;

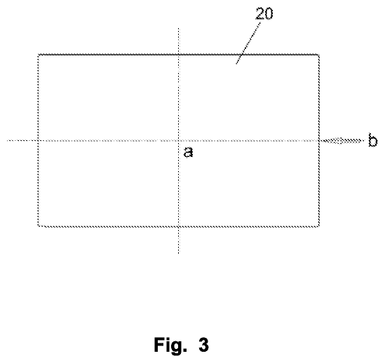

In order to perform drilling, cutting and/or marking operations on the sheet plate, while bridge (20) whereon cutting head group is connected moves back and forth by driving from driving component-1 (30) on guide component-1 (11) via guide component-2 (21) connected to both side surfaces, bridge driving point (b) and bridge weight axis (a) coincides as shown in FIG. 3 and bridge's (20) reaching higher accelerations is provided and higher quality cutting is obtained.

1. A bridge and body embodiment used in laser cutting machines comprising:
two bodies located facing each other and extending at least a first guide component along a length on an inner surface;
wherein the bridge moves back and forth on the first guide component by means of at least second one guide component connected in between the bodies in a perpendicular way and connected to both side surfaces;
a first driving component located on both side surfaces of the bridge or on the inner surface of the body and providing movement of the bridge; and
a second driving component located on the inner surface of the body and providing movement of the first driving component.
